(19) United States
(12) Patent Application Publication
(10) Pub. No.: US 2005/0151728 A1
(43) Pub. Date: Jul. 14, 2005

(54) Method and device for diplaying images

(76) Inventor: Petri Nenonen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/508,933

(22) PCT Filed: Mar. 28, 2002
(86) PCT No.: PCT/IB02/00978

(51) Int. Cl. G09G 5/00

(52) U.S. Cl. 345/204

(57) ABSTRACT

This invention relates to a method for improving a digital image for displaying an improved image on a display. According to the method, an instantaneous property of the display; a property of the digital image; and parameters for an image processing method are determined. The parameters are determined at least partly on the basis of the instantaneous property of the display, and the property of the digital image. Then the digital image is processed by means of the image processing method, while applying the parameters. The invention also relates to a mobile device as well as a display unit, which are arranged to employ the concept of the method.

### TECHNICAL FIELD

The present invention relates to displaying images on an electronic display.

### TECHNICAL BACKGROUND

A digital image has a particular appearance on a display. Further, the image is differently perceived by different individuals. In all, it is therefore not possible to obtain a general appearance, which is perceived as optimal by every individual. Additionally, variations in ambient light cause different conditions from time to time. This problem has been addressed in the U.S. Pat. No. 6,094,185, wherein computer display parameters are automatically adjusted in accordance with user preferences and ambient light. Thus, an individual is able to input preferred settings of the display, e.g. as regards brightness or contrast, and the ambient light is considered. On basis of the personal preferences, and the present ambient light, a display parameter, such as brightness or contrast is adjusted.

However, this method is far from optimal. One problem is that when adjusting a single display parameter, or property, other properties are often affected as well. In other words, negative resulting effects appear, which will have to be considered in order to achieve a desired appearance of the image on the display.

### SUMMARY OF THE INVENTION

An object of the present invention is to provide a solution to the problem of said resulting effects when adjusting a display parameter.

In accordance with a first aspect of the invention, the object is achieved with a method for improving a digital image for displaying an improved image on a display. The method comprises improving a digital image for displaying an improved image on a display, comprising:
determining an instantaneous property of the display;
determining a property of the digital image;
determining parameters for an image processing method at least partly on basis of said instantaneous property of the display, and said property of the digital image; and
processing the digital image by means of said image processing method, while applying said parameters.

Consequently, in accordance with the method according to the present invention, the problem of the resulting effects is basically solved, not by trying to avoid said resulting effects but by detecting them. When an (i.e. at least one) instantaneous display property is determined, the current state of the display is detected. Any changes affecting said property are thus considered by the method.

Further, according to the method, the very image is processed on basis of, inter alia, the instantaneous display property. It is to be noted that the thus improved image is improved as regards the appearance thereof on the display in question. Thus, rather than merely adjusting one or a few properties of the display, as in the prior art, properties of the very image are adjusted so as to adapt the image to the display on which it is displayed. The adjustment is performed on an instantaneous basis, i.e. on basis of said instantaneous property of the display. In other words, the current state of the property is determined, as a part of the image improvement method according to the present invention. Thus, not only static but also dynamic circumstances are taken into account by the method according to the invention. The tool for adjusting the image is an image processing method. The parameters for the method are set in dependence of properties of the original, non-improved image, and of the display.

As defined above, the scope of the method includes the option that several different properties of the image, and/or the display are taken into account. There are several different possible properties that said instantaneous property of the display can be chosen from, including, but not limited to, contrast, brightness, illumination, and color intensity. Some of these can be user-adjustable. Similarly, there are several different possible properties that said property of the image can be chosen from, including, but not limited to, contrast, brightness, sharpness, and contents or type of image, i.e. for example whether the image is imaginary or a photography.

In an embodiment of the method all measures, i.e. determining properties of the display and the image, determining parameters for an image processing method, and processing the digital image are repeated at a repetition rate. This means that the displayed image is adjusted at a determined rate in order to keep it optimised, despite changes in the display conditions appearing over time. The rate can be set such that the method runs continuously in a loop. In other words, the image is then reprocessed repeatedly.

In an embodiment of the method it comprises detecting a change in said instantaneous property of the display; and repeating said determining and processing measures when a change is detected. For example, this embodiment takes care of a situation where some display settings are user-specific, i.e. are adjustable by the user. As soon as a setting is changed by the user this is detected and compensated for, in order to retain the optimal image quality. Another example is a change in the illumination of the display, for example due to an external change, such as when the user passes from outdoors to indoors. In an embodiment of the method, the image processing method comprises at least one sub-method chosen from a group of sub-methods consisting of saturation increase, color componentwise histogram stretch, and unsharp masking.

This embodiment is preferred when the display is of a type having a small color gamut. Such displays are typical for applications where a low power consumption is desired. Such applications are typically mobile devices. Typical displays are transflective displays and the like, as will be further discussed below. An advantage of these simple methods is that they have small requirements of processing capacity, and thus they are suitable for mobile applications. Still the image improvement capability of these methods is enough for causing a significant improvement of the quality of the displayed image. To a man skilled in the art, this may seem contradictory, since these simple methods are known to be accompanied with some overcompensating properties, in turn causing undesired effects, as will be further explained below. However, it has turned out that these undesired effects are masked to a sufficient extent by said small color gamut displays, leaving, substantially, merely the image improvements to the eyes of a viewer.

In accordance with a second aspect of the invention, the object is achieved with a mobile device comprising a display unit, an image memory for holding a digital image, and an image improvement unit for improving said digital image, which is displayed on the display. The image improvement unit is arranged to process said digital image by means of an image processing method; and to determine parameters for said image processing method at least partly on basis of an instantaneous property of the display, and a property of the digital image.

As for the method the appearance of a displayed image is improved in relation to the prior art, since the device improves the very image, and, in doing so, takes into account the effect of adjustment on the instantaneous display property.

In an embodiment of the device according to the invention, the display is a reflective display or a transflective display. These display choices are preferred in a mobile unit due to the low power consumption thereof. As regards the transflective display, in a basic mode the display is solely reflective, but when the ambient light is not enough for illuminating the display an internal back-light is activated and adjusted according to the ambient light. On the other hand, the color gamuts of the reflective and transflective displays are limited. However, the present invention contributes substantially to the image quality and substantially reduces the drawbacks of these types of displays.

In accordance with a third aspect of the invention, the object is achieved with a display unit comprising: a display, an image memory for holding a digital image, and an image improvement unit for improving said digital image, which is displayed on the display. Said image improvement unit is arranged to process said digital image by means of at least one image processing method; and to determine parameters for said/each image processing method at least partly on the basis of an instantaneous property of the display, and a property of the digital image.

In accordance with a fourth aspect of the invention, the object is achieved with the use of at least one image processing method comprising at least one sub-method chosen from a group of sub-methods consisting of saturation increase, color componentwise histogram stretch, and unsharp masking, for improving a digital image for display in accordance with the method or mobile device above.

### BRIEF DESCRIPTION OF THE DRAWINGS

Exemplifying embodiments of the invention will be described below with reference to the accompanying drawings, in which:

FIG. 1 illustrates a schematic block diagram of central parts of an embodiment of a mobile device comprising image improvement circuitry, according to the invention;

FIG. 2 illustrates another embodiment of a mobile device; and

FIG. 3-5 illustrates different image processing methods.

### DESCRIPTION OF EMBODIMENTS

In the following the present invention is explained by means of an aspect where it is implemented in a mobile device. It is to be noted that the invention may as well be implemented in a stationary device.

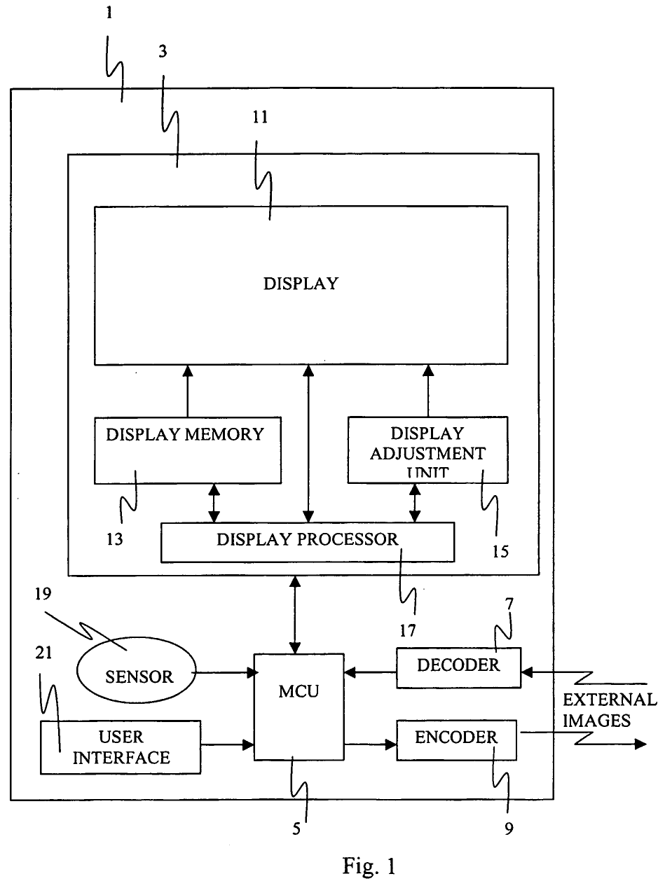

A mobile device 1, capable of handling images, according to a preferred embodiment, comprises a display unit 3, a control unit, such as a micro controller (MCU) 5, connected to the display unit 3, and a decoder and an encoder 7 and 9, respectively, for reception and transmission of external images, as shown in FIG. 1. The decoder 7 and the encoder 9 are connected to the micro controller 5.

The display unit 3 comprises a display 11, a display memory 13, connected to the display 11, for holding images which are displayed, a display adjustment unit 15, connected to the display 11, by means of which display properties are adjusted, and a display processor 17, connected to the display memory 13 and to the display adjustment unit 15. In this embodiment the display processor 17 serves as an image improvement unit. Further, the mobile device comprises an ambient light sensor 19, which is connected to the micro controller 5. As is understood to a man skilled in the art, the mobile device comprises many other parts and circuits in dependence of what type of device it is. However, for reasons of clarity and simplicity, merely those parts which are needed for the disclosure and explanation of the present invention are illustrated. It is an easy task for a skilled man to add general functionality in order to obtain a fully competent device, such as a mobile phone, a PDA device, i.e. a small mobile hand-held device that provides computing and information storage and retrieval capabilities for keeping schedule calendars and address book information handy, a laptop computer, i.e. an all-in-one computer that is easily portable, video glasses or other accessory devices to portable devices, etc.

The image improvement method of the present invention is now to be explained as performed by the device in FIG. 1. An image is received at the mobile device 1 and decoded in the decoder 7. The image is then stored in the display memory 13. Then, the image improvement unit, i.e. the display processor 17, determines a property, or typically several properties, of the image and compares these image properties with one or more properties of the display 11. In all situations where the properties of the image are not already optimised to the display 11, an improvement procedure is initiated. The display processor 17 manipulates the properties of the image, by means of an image processing method, employing at least one sub-method, or algorithm, for example one or more of those mentioned above, in order to improve the appearance of the image on the display 11. The improved image is stored in the display memory 13. Then the improved image is applied to the display 11 from the memory 13.

In a mobile device, a general aim is to minimise the power consumption of the circuitry of the device as well as of the processes run by the circuitry. It is therefore preferred that the display is of a low power type, and preferably is a reflective or transflective LCD display. As a contrast CRT displays can be mentioned, which have a relatively high power consumption. On the other hand, it has been shown that, at present, reflective and transflective LCD displays have some insufficient properties in comparison with, for example, CRT displays. The color gamuts of the low power displays are relatively small, and, additionally, they are dependent on the intensity and quality of the ambient light, and of the internal light source, which is energised when necessary. Further, the contrast ratio is quite low. These deficiencies result in that many images appear to have low contrast and faint colors. Consequently, preferred image processing algorithms are those which compensate for the low color gamut and low contrast ratio. There do exist advanced algorithms, which can be tailored for a certain type of display and adapt any image as far as possible. However, when it comes to a mobile device, the processing capacity thereof is limited, and so is the available power. Consequently, it is preferred that the image processing algorithms are simple and consume little power. It has proven possible to achieve this while still achieving a substantial improvement of the perceived image quality.

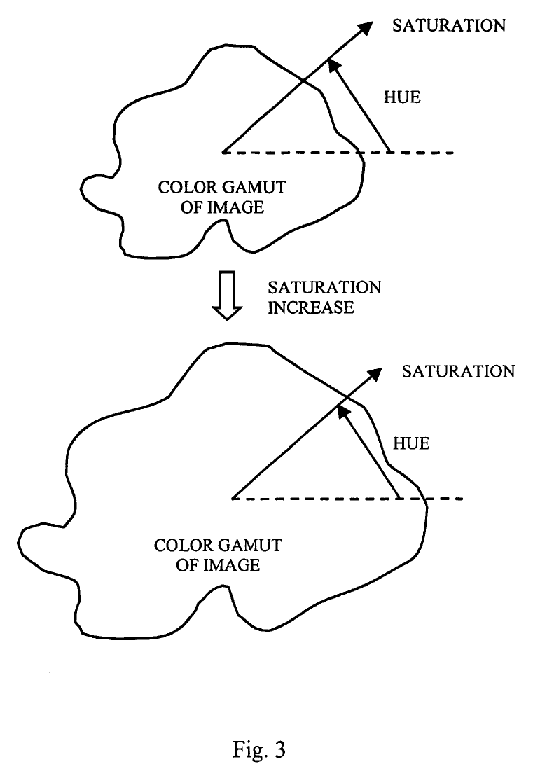

One useful image processing sub-method is a saturation increase algorithm, which increases the difference between grey and each color component. Thus, the saturation is increased, but typically, the image becomes over-saturated. However, due to the low color contrast of the low power display, the original image appears to be de-saturated, and therefore the increased saturation does not cause an over-saturation effect. This algorithm is illustrated in FIG. 3.

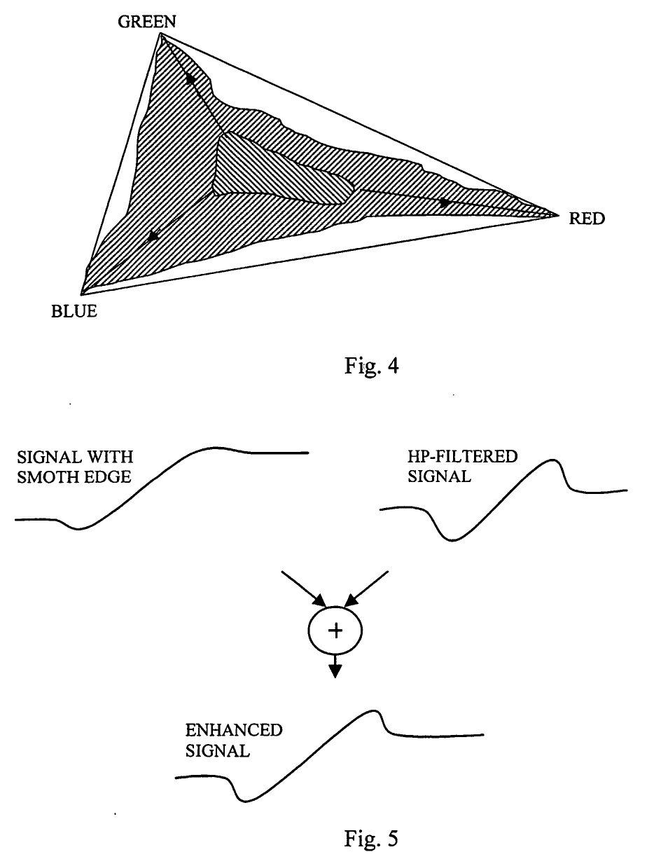

Another useful algorithm is a componentwise histogram stretching algorithm, which stretches the dynamic range of each color component of the image. After stretching, the dynamics of the image signal are effectively utilized. Typical drawbacks are over-colored image, resulting in contouring. It has proven that due to the low dynamics of the above-mentioned low-power displays, the contouring remains below a disturbing level, and the image does not appear to be over-colored. This algorithm is illustrated in FIG. 4, where the smaller hatched area represents the color gamut of the original image, and the larger hatched area represents the color gamut of the improved image.

Yet another useful algorithm is an unsharp masking algorithm, wherein a high pass filtered version of the image is added to the original image. This algorithm is illustrated in FIG. 5, where a signal of the image is shown to the upper left, a high pass filtered version of the signal is shown to the upper right, and the sum thereof is shown at the bottom of the figure. The algorithm increases local contrast around edges. Visibility and subjective sharpness of edges are increased. This algorithm produces ringing artefacts around edges, and it increases the visibility of noise. However, due to a typical small pixel size of the low power display, for example, the ringing does not become disturbingly visible. Further, the visibility of noise is not high, because the display have low contrast capability. As regards the noise, in fact a small amount of noise hides the possible contouring artefacts, which are due to other algorithms or due to the properties of the display.

These algorithms can be combined, i.e. the image processing method can make use of a plurality of the algorithms for improving the image to an optimal extent.

The display processor 17 determines the parameters to be used by the image processing method from a combination of properties of the image and the display. More particularly, the image is analysed, and preferably statistical properties are measured, for example by means of histograms. As regards the display 11, at least some properties are known to the display processor 17 beforehand. Typically, information about the display properties is read from the display unit 3, or stored in the memory of the device, when the display unit is installed into the device 1. In addition to the color gamut and color contrast ratio mentioned above, also for example the instantaneous brightness can be taken into account. All these display properties are changing dynamically, and in some cases the display properties can be adjusted from time to time by the user, who has the opportunity to input desired settings of the display. These user-specific display settings are then performed by means of the display adjustment unit 15, which, in this embodiment, receives the data for the settings from the micro controller 5. The micro controller 5, in turn, has received them via a user interface 21.

The display processor 17, at a predetermined repetition rate, repeatedly evaluates the instantaneous state of the display, i.e. the instantaneous properties thereof, by obtaining that information from the display adjustment unit 15. Then the display processor uses that information in conjunction with information of the image for determining new parameters for the image processing and provides these parameters to the display processor, which uses them when performing the image processing method. Finally the image is readjusted. The repetition rate can differ according to what is appropriate in a specific application. However, a typical rate is the highest possible, in which case the image improvement method runs continuously in a loop.

In one embodiment, for every repetition of the image improvement method, the image processing method is applied to the original image. At least this applies for those algorithms that use statistical computations. Thus, in this embodiment, the original image as well as the improved image are stored. On the other hand, in some cases it is possible to readjust the most recently improved image, although most often this distorts the image in an undesired way.

In addition, or as an alternative, to the above-described repetitive readjustment of the image, the readjustment of the image is performed when the circumstances are changed. In this case, the display properties on which the image processing is based are monitored by means of the image improvement unit, i.e. in this embodiment the display processor 17. When a significant change is detected in a display property the image improvement processing is initiated, which often results in a readjustment of the improved image in the display memory 13.

Another factor to be considered when the image is improved is the illumination of the display 11. The amount of illumination has an effect on the available contrast and color contrast, especially when the display is reflective. The quality of the illumination is also important. For example, the color of the illumination affects the color gamut of the display 11. Thus, in this embodiment, the micro controller 5 receives data from the sensor 19 as to the amount and quality of the ambient light. The micro controller 5 then provides the display processor 17 with corresponding information, and the display processor 17 combines said information with knowledge of a possible contribution from the internal light of the display. Also, the display processor controls the switching of the internal light.

Yet another factor that can be considered is the temperature. The temperature has an effect on the operation of LCDs. More particularly, the contrast and the color properties of the display are temperature dependent.

When the display is transflective, the determination of the parameters for the image processing algorithm is preferably also based on the operation mode. In other words, it is detected if the display is in the reflective mode or in the transmissive mode, since the operation mode has an effect on the color gamut.

Due to the simple methods of image improvement the display processor can be rather simple, which is an advantage.

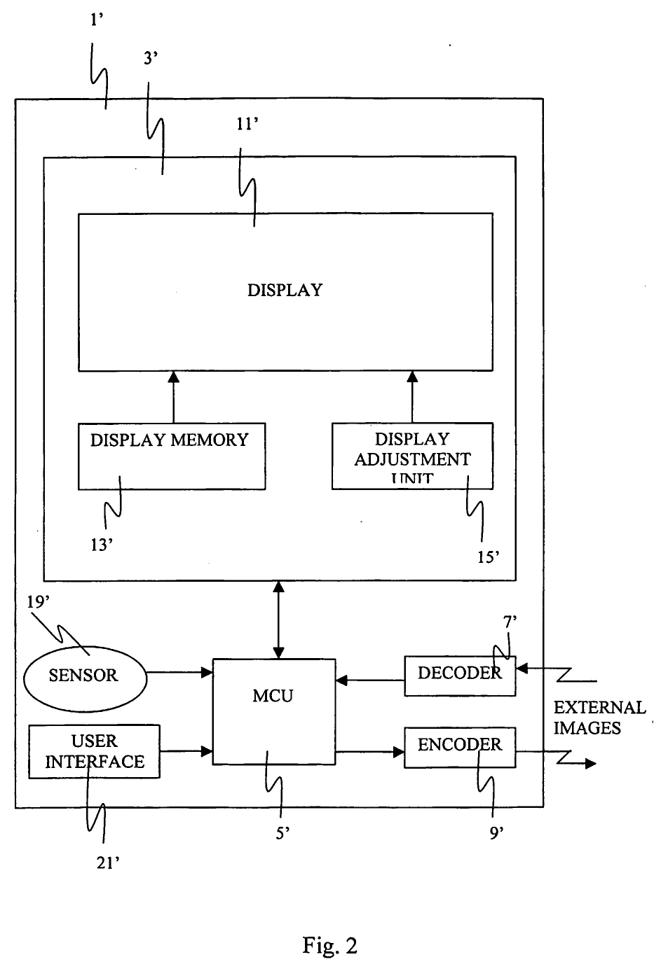

In another embodiment of the mobile device, as shown in FIG. 2, the display processor is omitted. The parts of the second embodiment that have a correspondence in the first embodiment are provided with corresponding numerals, though provided with an accent. In this second embodiment the image improvement processing is performed by the micro controller 5′. Thus, the properties of the display 11′ that are not static, and thus can not be predetermined, are transferred from the display unit 3′ to the micro controller 5′.

1. A method for improving a digital image displayed on a display, comprising:
determining an instantaneous property of the display;
determining a property of the digital image;
determining parameters for an image processing method at least partly on the basis of said instantaneous property of the display, and said property of the digital image; and
processing the digital image by means of said image processing method, while applying said parameters.

2. A method according to claim 1, wherein all measures are repeated at a repetition rate.

3. A method according to claim 2, further comprising:
detecting a change in said instantaneous property of the display; and
repeating said determining and processing measures when a change is detected.

4. A method according to claim 3, wherein said determination of parameters is further based on an operation mode of the display.

5. A method according to claim 4, wherein the digital image is adapted to one display out of a group of displays consisting of reflective and transflective displays.

6. A method according to claim 5, wherein said image processing method comprises at least one sub-method chosen from a group of sub-methods consisting of saturation increase, color componentwise histogram stretch, and unsharp masking.

7. A mobile device comprising a display unit, an image memory for holding a digital image, and an image improvement unit for improving said digital image displayed on the display unit, said image improvement unit being arranged to process said digital image by means of an image processing method; to determine parameters for said image processing method at least partly on the basis of an instantaneous property of the display, and a property of the digital image.

8. A mobile device according to claim 7, with said display being one of a reflective and a transflective display.

9. A mobile device according to claim 8, wherein said image improvement unit is provided in said display unit.

10. A mobile device according to claim 9, wherein said image improvement unit is provided outside of the display unit, and is arranged to communicate therewith.

11. A display unit comprising a display, an image memory for holding a digital image, and an image improvement unit for improving said digital image displayed on the display, said image improvement unit being arranged to process said digital image by means of at least one image processing method; to determine parameters for said image processing method at least partly on the basis of an instantaneous property of the display, and a property of the digital image.

12. A use of an image processing method comprising at least one sub-method chosen from a group of sub-methods consisting of saturation increase, color componentwise histogram stretch, and unsharp masking, for improving a digital image for display in accordance with claim 1.

13. A use of an image processing method comprising at least one sub-method chosen from a group of sub-methods consisting of saturation increase, color componentwise histogram stretch, and unsharp masking, in a mobile device according to claim 7.

14. A method according to claim 1, further comprising:
detecting a change in said instantaneous property of the display; and
repeating said determining and processing measures when a change is detected.

15. A method according to claim 1, wherein said determination of parameters is further based on an operation mode of the display.

16. A method according to claim 1, wherein the digital image is adapted to one display out of a group of displays consisting of reflective and transflective displays.

17. A method according to claim 1, wherein said image processing method comprises at least one sub-method chosen from a group of sub-methods consisting of saturation increase, color componentwise histogram stretch, and unsharp masking.

18. A mobile device according to claim 7, wherein said image improvement unit is provided in said display unit.

19. A mobile device according to claim 7, wherein said image improvement unit is provided outside of the display unit, and is arranged to communicate therewith.
